(19) United States
(12) Patent Application Publication
(10) Pub. No.: US 2011/0304675 A1
(43) Pub. Date: Dec. 15, 2011

(54) FLUID EJECTING APPARATUS

(75) Inventor: Seiji TOJO, Shiojiri-shi (JP)

(73) Assignee: SEIKO EPSON CORPORATION, Tokyo (JP)

(21) Appl. No.: 13/112,666

(22) Filed: May 20, 2011

(30) Foreign Application Priority Data
Jun. 11, 2010 (JP) 2010-134235

(51) Int. Cl. B41J 2/175

(52) U.S. Cl. 347/85

(57) ABSTRACT

The fluid ejecting apparatus includes a fluid ejecting head that ejects fluid, a fluid receiving unit that receives the fluid ejected from the fluid ejecting head, a fluid absorbing unit that is connected to the fluid receiving unit via a flow channel and absorbs the fluid, a pump that is provided on the flow channel and pumps the fluid from the fluid receiving unit to the fluid absorbing unit and an actuating unit that distributes the fluid ejected from the flow channel to the fluid absorbing unit in conjunction with actuation of the pump.

### CROSS REFERENCES TO RELATED APPLICATIONS

The present invention contains subject matter related to Japanese Patent Application No. 2010-134235, filed Jun. 11, 2010, the entire contents of which are incorporated herein by reference.

### BACKGROUND

1. Technical Field

The present invention relates to fluid ejecting apparatuses.

2. Related Art

Fluid ejecting apparatuses that eject fluid are known, including an ink jet recording apparatus such as disclosed in JP-A-2009-78417. An Ink jet recording apparatus is an apparatus that records characters and images on a recording medium (a medium) by ejecting ink on the medium. The ink jet recording apparatus includes an ejection head having nozzles that selectively eject ink.

The ink jet recording apparatus regularly performs maintenance operations for its recording head, such as a capping operation for covering the ejection plane where nozzles are formed and flushing operation or suctioning operation for discharging ink from nozzles, in order to maintain or recover a good ejection property. Ink ejected from the nozzles is collected, for example, in a waste ink recovering unit. The waste ink recovering unit includes an absorption member that absorbs ink.

In maintenance, ink recovery is performed, for example, by allowing ink to be absorbed in the absorption member and replacing such an absorption member. Accordingly, the recovery efficiency is improved when ink is absorbed in the absorption member as evenly as possible. In order to achieve such efficient absorption, configurations have been proposed such as that using a material having high permeability for ink and that providing a drive source for moving ink separately from a drive source for suctioning ink, for example as disclosed in JP-A-2009-78417.

However, such a material having high permeability for ink is generally expensive. Further, additional cost is incurred when a drive source is provided separately from a drive source for suctioning ink. Accordingly, those configurations have had a problem with the cost.

### SUMMARY

An advantage of some aspects of the invention that a fluid ejecting apparatus capable of evenly absorbing ink and reducing the cost is provided.

According to an aspect of the invention, a fluid ejecting apparatus includes a fluid ejecting head that ejects fluid, a fluid receiving unit that receives the fluid ejected from the fluid ejecting head, a fluid absorbing unit that is connected to the fluid receiving unit via a flow channel and absorbs the fluid, a pump that is provided on the flow channel and pumps the fluid from the fluid receiving unit to the fluid absorbing unit and an actuating unit that distributes the fluid ejected from the flow channel to the fluid absorbing unit in conjunction with actuation of the tube pump.

Accordingly, the actuating unit is provided to distribute the fluid from the flow channel to the fluid absorbing unit, thereby allowing the fluid from the flow channel to be distributed to the fluid absorbing unit. Further, the actuating unit that actuates in conjunction with actuation of the pump enables to reduce the cost of the fluid ejecting apparatus regardless of the material of the fluid absorbing unit and without providing a separate drive power source.

According to above aspect of the invention, the fluid ejecting apparatus includes the actuating unit having a relative driving mechanism that moves the fluid ejected to the fluid absorbing unit and the fluid absorbing unit relative to each other. Accordingly, it is possible to move the fluid ejected to the fluid absorbing unit and the fluid absorbing unit relative to each other, thereby allowing the fluid from the flow channel to be distributed to the fluid absorbing unit with a higher certainty.

According to above aspect of the invention, the fluid ejecting apparatus includes the actuating unit having a turbine that rotates due to a fluid flow caused by the pump and a transmission mechanism that is rotatable integrally with the turbine and transmits a rotation force of the turbine to the relative driving mechanism as a driving force. Accordingly, it is possible to move the fluid and the fluid absorbing unit relative to each other by a driving force generated by a rotation force of the turbine that is rotated due to the fluid flow caused by the pump, therefore the relative movement is achieved in an efficient manner.

According to above aspect of the invention, the fluid ejecting apparatus includes the relative driving mechanism having an absorbing unit driving mechanism that actuates the fluid absorbing unit. Accordingly, it is possible to move the fluid and the fluid absorbing unit relative to each other by actuating the fluid absorbing unit, thereby allowing the fluid from the flow channel to be distributed to the fluid absorbing unit with a higher certainty.

According to above aspect of the invention, the fluid ejecting apparatus includes the fluid absorbing unit having a first absorption member provided at a position where the fluid is ejected from the flow channel and a second absorption member provided in contact with the first absorption member and the absorbing unit driving mechanism having a rotating mechanism that rotates the first absorption member. Accordingly, the fluid from the flow channel is ejected to the first absorption member, and then, when the first absorption member rotates, the ejected fluid moves away from the ejection port, thereby allowing the fluid at the ejected position to be absorbed in the second absorption member, which is in contact with the first absorption member. This makes it possible to move the fluid without using a material having high permeability, thereby allowing the fluid to be distributed substantially over the entirety of the fluid absorbing unit with a higher certainty.

According to above aspect of the invention, the fluid ejecting apparatus includes the relative driving mechanism having a fluid driving mechanism that drives the fluid. Accordingly, it is possible to move the fluid and the fluid absorbing unit relative to each other by driving the fluid, thereby allowing the fluid from the flow channel to be distributed to the fluid absorbing unit with a higher certainty.

According to above aspect of the invention, the fluid ejecting apparatus includes the transmission mechanism having a shaft member that is connected to the turbine and rotates integrally with the turbine and the fluid driving mechanism having threads formed in a spiral shape on the surface of the shaft member. Accordingly, when the shaft member connected to the turbine rotates, the threads formed in a spiral shape on the surface of the shaft member moves to scoop out the fluid, thereby allowing the fluid to be moved with certainty.

According to above aspect of the invention, the fluid ejecting apparatus includes the fluid driving mechanism having a stirring mechanism that stirs the fluid between the flow channel and the fluid absorbing unit. Accordingly, it is possible to stir the fluid between the flow channel and the fluid absorbing unit, thereby allowing the fluid to be distributed substantially over the entirety of the fluid absorbing unit with a higher certainty.

### BRIEF DESCRIPTION OF THE DRAWINGS

The invention will be described with reference to the accompanying drawings, wherein like numbers reference like elements,

FIG. 1 is a schematic view showing a configuration of a printing apparatus according to a first embodiment of the present invention.

FIG. 2 is a schematic sectional view showing a configuration of a head according to the first embodiment.

FIG. 3 is a schematic sectional view showing a configuration of a head according to the first embodiment.

FIG. 4 is a view showing a configuration of a waste ink recovering mechanism according to the first embodiment.

FIG. 5 is a view partially showing a configuration of the waste ink recovering mechanism according to the first embodiment.

FIG. 6 is a block diagram of a configuration of a control system.

FIG. 7 is a view showing an operation of the waste ink recovering mechanism of the printing apparatus according to the first embodiment.

FIG. 8 is a view partially showing a configuration of a printing apparatus according to a second embodiment of the invention.

FIG. 9 is a view partially showing a configuration of a printing apparatus according to a third embodiment of the invention,

### DESCRIPTION OF EXEMPLARY EMBODIMENTS

### First Embodiment

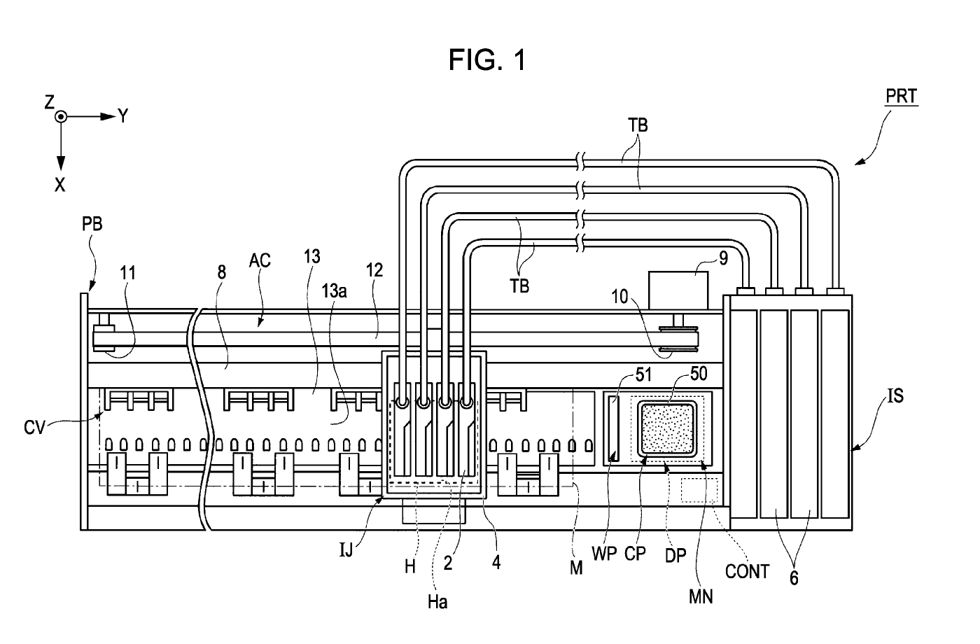

A first embodiment of the present invention will be described below with reference to the attached drawings. FIG. 1 is a view schematically showing a configuration of a printing apparatus PRT (liquid ejecting apparatus) according to a first embodiment. In this embodiment, an ink jet type printing apparatus will be described as an example of the printing apparatus PRT.

The printing apparatus PRT that is shown in FIG. 1 performs printing while transporting a sheet medium M, such as a paper sheet or a plastic sheet. The printing apparatus PRT includes a housing PB, an ink jet mechanism IJ that ejects ink to the medium M, an ink supplying mechanism SP that supplies ink to the ink jet mechanism IJ, a transportation mechanism CV that transports the medium M, and a maintenance mechanism MN that performs a maintenance operation for the ink jet mechanism IJ and a controller CONT that controls each of the above mechanisms.

In this embodiment, ink that contains coloring materials (functional materials) dispersed in a liquid medium such as water is used. Although ink generally has a water content of approximately 70%, high viscosity ink whose water content is approximately 50% may also be used. Further, a commercial printing apparatus may also be used for the printing apparatus PRT of this embodiment.

An XYZ rectangular coordinate system is provided and used as appropriate to explain the positional relationship between the components in the following description. In this embodiment, for example, a transportation direction of the medium M is defined as the X direction, a direction perpendicular to the X direction in the transportation plane of the medium M is defined as the Y direction, and a direction perpendicular to a plane containing the X and Y axes is defined as the Z direction. Further, a rotation direction about the X axis is defined as a θX direction, a rotation direction about the Y axis is defined as a θY direction, and a rotation direction about the Z axis is defined as a θZ direction.

The housing PB has a longitudinal direction, for example, in the Y direction. The housing PB includes the ink jet mechanism IJ, the ink supplying mechanism SP, the transportation mechanism CV, the maintenance mechanism MN and the controller CONT. The housing PB is provided with, for example, a platen 13 which is a support member that supports the medium M. The platen 13 is arranged at the center of the X direction in the housing PB. The platen 13 has a flat surface 13a which is oriented in the positive Z direction. The flat surface 13a is used as a support plane that supports the medium M.

The transportation mechanism CV includes, for example, a transportation roller and a motor to actuate the transportation roller. The transportation mechanism CV works, for example, to transport the medium M from the negative X axis side of the housing PB into the inside of the housing PB and discharge the medium M from the positive X axis side of the housing PB to the outside of the housing PB. The transportation mechanism CV transports the medium M such that the medium M passes over the platen 13 within the housing PB. The transportation mechanism CV controls the timing of transportation, the transportation distance, and the like, for example, by the controller CONT.

The ink jet mechanism IJ includes a head H that ejects ink and a head actuating mechanism AC that holds and moves the head H. The head H ejects ink to the medium M which is fed on the platen 13. The head H has an ejection plane Ha which is formed to eject ink. The ejection plane Ha is oriented, for example, in the negative Z direction and arranged, for example, so as to oppose the support plane 13a of the platen 13.

The head actuating mechanism AC includes a carriage 4. The head H is secured to the carriage 4. The carriage 4 abuts a guiding shaft 8 which extends in the longitudinal direction (X direction) of the housing PB. The head H and the carriage 4 are arranged, for example, in the positive Z direction of the platen 13.

The head actuating mechanism AC includes in addition to the carriage 4, for example, a pulse motor 9, a driving pulley 10 that is driven to rotate by the pulse motor 9, a free rolling pulley 11 that is disposed on the side opposite the driving pulley 10 in the width direction of the printer body 5, and a timing belt 12 which runs between the driving pulley 10 and the free rolling pulley 11 and is connected to the carriage 4.

The carriage 4 is connected to the timing belt 12. As the timing belt 12 rotates, the carriage 4 is movable in the Y direction. The carriage 4 is guided by the guiding shaft 8 while being moved in the Y direction.

The ink supplying mechanism SP supplies ink to the head H. The ink supplying mechanism SP houses, for example, a plurality of ink cartridges 6. The printing apparatus PRT according to this embodiment is configured such that the ink cartridge 6 is housed at a different position from the head H (off-carriage type), The ink supplying mechanism SP includes a supplying tube TB that connects, for example, the head H and the ink cartridge 6. The ink supplying mechanism SP includes a pump mechanism, which is not shown, that supplies ink to the head H via the supplying tube TB so that ink is reserved in the ink cartridge 6.

The maintenance mechanism MN is placed at a home position in the head H. The home position is located in the area, for example, other than that where printing is performed on the medium M. In this embodiment, the home position is located, for example, on the positive Y axis side of the platen 13. The home position is a position where the head H is positioned, for example, when the printing apparatus PRT is powered off or does not perform printing for a long period of time.

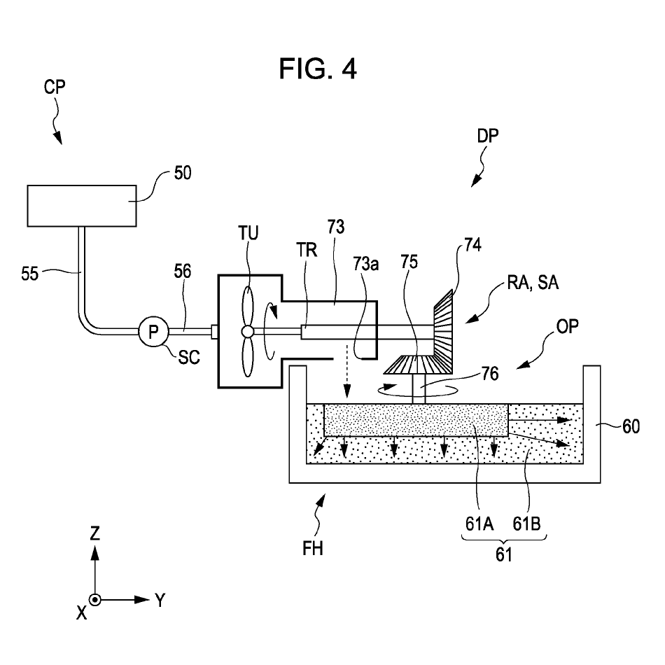

The maintenance mechanism MN includes, for example, a capping mechanism CP that covers the ejection plane Ha of the head H, a wiping mechanism WP that wipes the ejection plane Ha and the like. The capping mechanism CP has a capping member 50. The capping member 50 is connected to, for example, a tube pump SC such as a suction pump (FIG. 4). The capping mechanism CP may, for example, cover the ejection plane Ha while suctioning the space above the ejection plane Ha by using the tube pump SC. The waste ink discharged from the head H toward the maintenance mechanism MN is recovered, for example, in the waste ink recovering mechanism DP. The wiping mechanism WP has a wiping member 51.

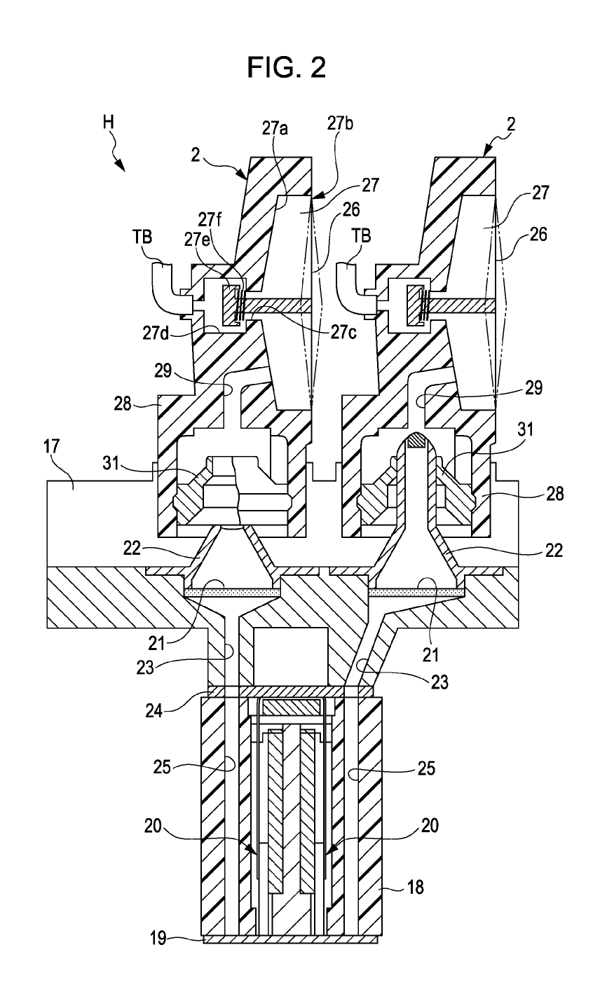

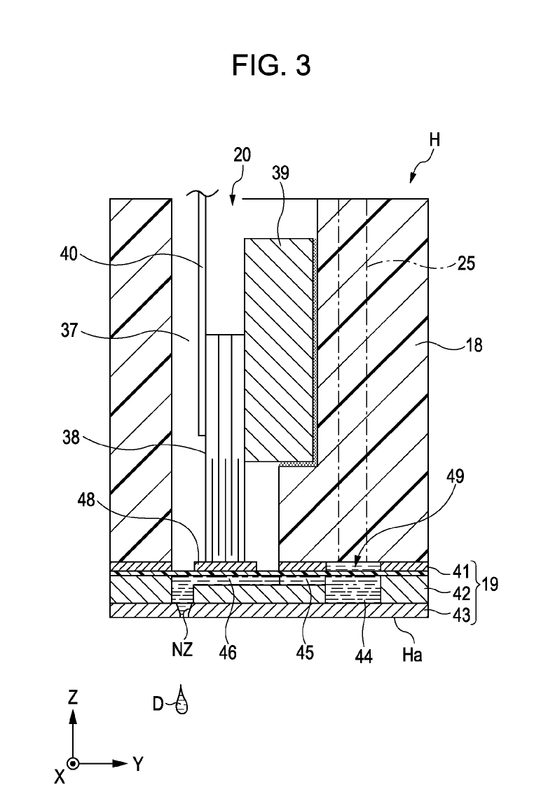

FIG. 2 is a side sectional view showing a configuration of the head H. FIG. 3 is a sectional view showing a configuration of the essential part of the head H.

As shown in FIG. 2, the head H includes an introduction needle unit 17, a head case 18, a flow channel unit 19 and an actuator unit 20.

Two ink introduction needles 22 are mounted on the top surface of the introduction needle unit 17 with filters 21 being interposed therebetween. Within each of the introduction needle units 17, ink introduction channels 23 are formed so as to correspond to the respective ink introduction needles 22. The upper end of the ink introduction channel 23 is connected to the ink introduction needle 22 via a filter 21. The lower end of the ink introduction channel 23 is connected to a case flow channel 25 within the head case 18 via a packing 24. Each of the ink introduction needles 22 are connected to the respective sub-tanks 2.

The sub-tank 2 is made of, for example, a resin material such as polypropylene. Each sub-tank 2 includes an ink chamber 27. The ink chamber 27 has a recess 27a, for example, formed in a circular cone shape. The recess 27a has an opening 27b. A transparent elastic sheet 26 is adhered over the opening 27b. Further, a communication hole 27c is formed at the bottom of the recess 27a. The recess 27a and an ink supplying chamber 27d of the ink chamber 27 communicate with each other through the communication hole 27c. The ink supplying chamber 27d is connected to, for example, the supplying tube TB. A filter, for example, is used at a connection portion between the supplying TB and the ink supplying chamber 27d (not shown).

The elastic sheet 26 is adhered to the opening 27b so as to cover the opening 27b. The elastic sheet 26 expands or contracts in response to changes in pressure of the ink chamber 27. For example, the elastic sheet 26 expands toward the outside of the recess 27a when the pressure inside the ink chamber 27 is greater than the outside pressure, thereby increasing the volume of the ink chamber 27. The elastic sheet 26 expands toward the inside of the recess 27a when the pressure inside the ink chamber 27 is lower than the outside pressure, thereby decreasing the volume of the ink chamber 27,

The elastic sheet 26 is equipped with a valve 27e. The valve 27e is connected from the recess 27a to the ink supplying chamber 27d via the communication hole 27c and configured to open and/or close the communication hole 27c from the side of the ink supplying chamber 27d. The valve 27e is configured to open and/or close the communication hole 27c in accordance with expansion and/or contraction of the elastic sheet 26. Specifically, the communication hole 27c is opened when the elastic sheet 26 expands in the direction in which the volume of the ink chamber 27 decreases, while the communication hole 27c is closed when the elastic sheet 26 expands in the direction in which the volume of the ink chamber 27 increases, The valve 27e is provided with a biasing member 27f to apply a predetermined elastic force so as to adjust the pressure to open and/or close the communication hole 27c.

The sub-tank 2 is connected to a needle connection portion 28. The needle connection portion 28 is a part that connects the sub-tank 2 and the ink introduction needle 22. A connection flow channel 29 is formed in the recess 27a of the ink chamber 27 so as to be connected with the needle connection portion 28. A sealing material 31 is provided inside the needle connection portion 28 so that the ink introduction needle 22 is fitted therein substantially without leaving a gap. When the ink introduction needle 22 is fitted in the sealing material 31, the sub-tank 2 and the introduction needle unit 17 are connected with each other without substantial leakage.

As shown in FIG. 3, the head case 18 is made of synthetic resin or the like. The head case 18 is formed, for example, in a box shape having a cavity therein. The upper side of the head case 18 is attached to the introduction needle unit 17 with the packing 24 being interposed therebetween, while the lower side of the head case 18 is attached to the flow channel unit 19. The actuator unit 20 is housed in a cavity 37 which is formed within the head case 18.

The head case 18 is provided with the case flow channel 25 extending therethrough in the height direction. The upper end of the case flow channel 25 communicates with the ink introduction channel 23 of the introduction needle unit 17 via the packing 24. The lower end of the case flow channel 25 communicates with a common ink chamber 44 in the flow channel unit 19. Accordingly, an ink D which is introduced from the ink introduction needle 22 and supplied to the common ink chamber 44 through the ink introduction channel 23 and the case flow channel 25

The actuator unit 20 includes a plurality of piezoelectric transducers 38 which are arranged, for example, in a comb tooth shape, a fixation plate 39 that holds the piezoelectric transducers 38 and a flexible cable 40 that supplies driving signals from the controller CONT to the piezoelectric transducers 38.

The piezoelectric transducers 38 are secured to the fixation plate 39 such that the lower end of the piezoelectric transducers 38 extend from the lower end of the fixation plate 39. Thus, the respective piezoelectric transducers 38 are mounted on the fixation plate 39 in a so-called cantilever shape. The fixation plate 39 that supports the respective piezoelectric transducers 38 is formed of, for example, stainless steel having a thickness of approximately 1 mm. A side on the fixation plate 39, for example, which is different from that to which piezoelectric transducers 38 are secured is bonded to an inner wall surface of the case that separates the cavity 37.

The flow channel unit 19 is composed of a vibration plate 41, a flow channel substrate 42 and a nozzle substrate 43. The vibration plate 41, the flow channel substrate 42 and the nozzle substrate 43 are bonded to each other while being stacked. The flow channel unit 19 forms a series of ink flow channels (liquid flow channels) from the common ink chamber 44 through the ink supplying port 45 and the pressure chamber 46 to the nozzles NZ. The pressure chamber 46 is formed so as to have the longitudinal direction perpendicular to the rows of nozzles NZ (nozzle row direction).

The common ink chamber 44 is connected to the case flow channel 25, The common ink chamber 44 is a chamber in which the ink D is introduced from the ink introduction needle 22. Further, the common ink chamber 44 is connected to the ink supplying port 45. The ink D introduced to the common ink chamber 44 is distributed to the respective pressure chambers 46 through the ink supplying port 45.

The nozzle substrate 43 is disposed at the bottom of the flow channel unit 19. A plurality of nozzles NZ is formed on the nozzle substrate 43 at a pitch corresponding to the dot formation density (for example, 180 dpi) of an image or the like to be formed on the medium M. The nozzle substrate 43 is formed of a metal plate material such as stainless steel.

FIG. 4 is a view showing a configuration of a capping mechanism CP, a tube pump SC and a waste ink recovering mechanism DP. In the following description, the positional relationship between the capping mechanism CP, the tube pump SC and the waste ink recovering mechanism DP may be explained using the same XYZ coordinate system as that of FIGS. 1 to 3, however the described positional relationship is merely exemplary and the invention is not limited to the described positional relationship.

As shown in FIG. 4, the capping mechanism CP and the tube pump SC are connected by a waste ink tube 55. Further, the tube pump SC and the waste ink recovering mechanism DP are connected by a waste ink tube 56. The waste ink tubes 55 and 56 are made of, for example, a flexible material such as rubber. When the waste ink tubes 55 and 56 are configured to be flexible, the design freedom for the capping mechanism CP, the tube pump SC and the waste ink recovering mechanism DP is improved. The tube pump SC exerts suction force from the capping mechanism CP to the waste ink recovering mechanism DP.

The waste ink recovering mechanism DP includes waste ink collecting mechanism FH and an operating mechanism OP. The waste ink collecting mechanism FH collects the waste ink that has flowed through the capping mechanism CP and the tube pump SC. The waste ink collecting mechanism FH has a container 60 and an absorption member 61. The container 60 is formed, for example, in a cylindrical shape. The absorption member 61 is disposed inside the container 60 The absorption member 61 is made of, for example, a porous material so as to be capable of absorbing the waste ink.

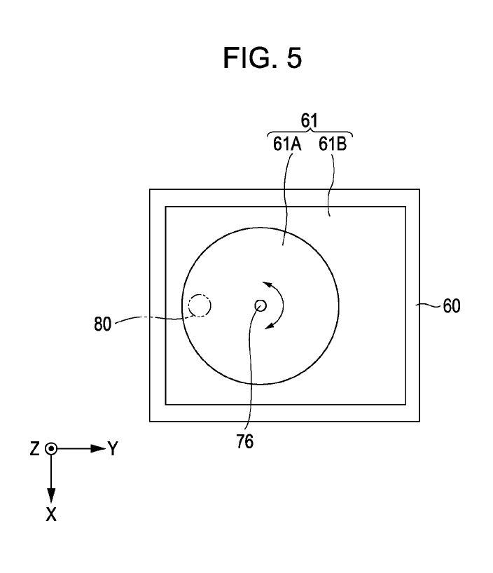

FIG. 5 is a plan view showing a configuration of the waste ink collecting mechanism FH. As shown in FIG. 5, the absorption member 61 includes a first absorption member 61A and a second absorption member 61B. The first absorption member 61A is for example formed in a circular shape in plan view, and for example arranged in a region containing a position 80 where ink arrives from the waste ink tube 56.

The second absorption member 61B is arranged so as to be in contact with the first absorption member 61A. Specifically, the second absorption member 61B is of a substantially cuboid shape and has a recess in which the first absorption member 61A is fitted. The recess is formed having approximately the same dimensions as those of the first absorption member 61A (such as the dimension in the Z direction and the length the XY plane). As a result, the second absorption member 61B is in contact with the bottom and the outer circumference of the first absorption member 61A. Further, the first absorption member 61A and the second absorption member 61B are arranged such that their top surfaces are substantially flush with each other, and thus assume a substantially cuboid shape with the first absorption member 61A being fitted in the second absorption member 61B.

The first absorption member 61A is formed to be separated from the second absorption member 61B. As a consequence, the first absorption member 61A can be moved or rotated in the Z direction independently from the second absorption member 61B. The second absorption member 61B is arranged, for example, in the container 60 without leaving a gap therebetween and is not movable relative to the container 60.

The operating mechanism OP operates to distribute ink from the waste ink tube 56 substantially over the entirety of the absorption member 61 in conjunction with actuation of the tube pump SC. The operating mechanism OP includes a cylindrical member 73, a turbine TU, a transmission shaft TR and a relative driving mechanism RA.

The cylindrical member 73 is connected to the waste ink tube 56. Ink from the waste ink tube 56 flows into the cylindrical member 73. The cylindrical member 73 is for example, arranged to extend in the Y direction. The cylindrical member 73 is formed such that ink can flow therethrough. The cylindrical member 73 has an opening 73a which is formed on the negative Z axis side of the cylindrical member 73. The opening 73a is oriented, for example, toward the absorption member 61. Consequently, ink flowing in the cylindrical member 73 flows out of the opening 73a as appropriate to a discharge position 80 on the absorption member 61. Thus, the absorption member 61 is disposed at the discharge position 80 where ink is discharged such that the first absorption member 61A is disposed at the discharge position 80,

The turbine TU is arranged in the cylindrical member 73 at a position where ink flows from the waste ink tube 56. The turbine TU is rotatable in the θY direction, for example, by the flow of ink, air or the like from the waste ink tube 56. The transmission shaft TR is connected to the turbine TU and arranged, for example, in the Y direction. The transmission shaft TR is rotatable integrally with the turbine TU. The transmission shaft TR is arranged such that a portion thereof extends outside the cylindrical member 73.

A relative driving mechanism RA is configured to move ink and the absorption member 61 relative to each other. In this embodiment, the relative driving mechanism RA moves ink and the absorption member 61 relative to each other by rotating the absorption member 61 in the θZ direction relative to ink that flows from the opening 73a. The configuration of the relative driving mechanism RA will be described below.

The relative driving mechanism RA has an absorption member driving mechanism SA to rotate the absorption member 61. The absorption member driving mechanism SA includes a first bevel gear 74, a second bevel gear 75 and a shaft 76. The first bevel gear 74 is mounted on the transmission shaft TR, for example, at a position extending from the cylindrical member 73. The first bevel gear 74 is rotatable integrally with the transmission shaft TR (turbine TU). Accordingly, the rotation direction of the first bevel gear 74 is the θY direction.

The second bevel gear 75 is in mesh with the first bevel gear 74 The second bevel gear 75 is rotatable in the θZ direction. Accordingly, the rotation is transmitted via the transmission shaft TR to the shaft 76 with the rotation direction being transformed by the first bevel gear 74 and the second bevel gear 75. The shaft 76 is connected to the second bevel gear 75 at one end thereof (an upper end in the figure) and to the center of the first absorption member 61A at the other end thereof (a lower end in the figure). The shaft 76 is rotatable integrally with the second bevel gear 75 and the first absorption member 61A in the OZ direction.

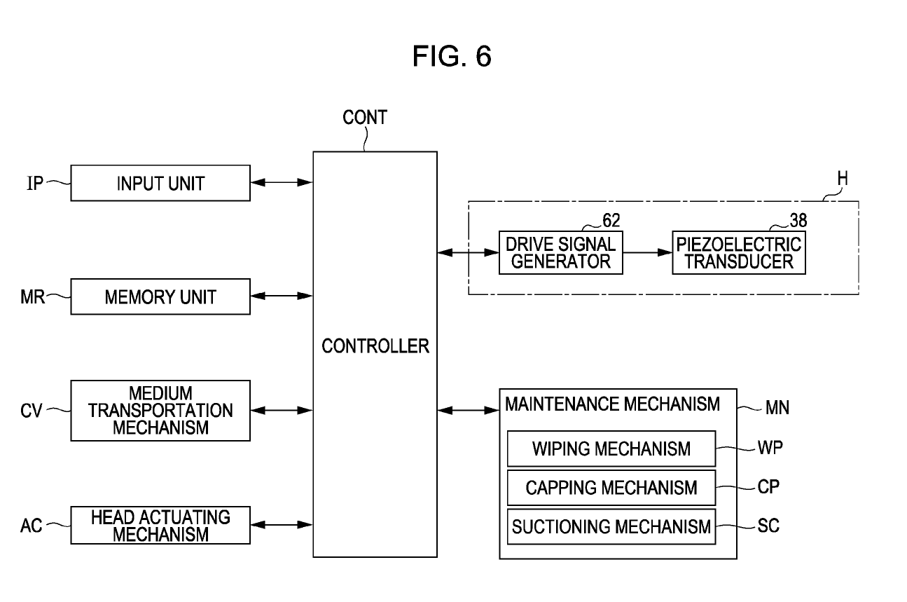

FIG. 6 is a block diagram showing an electric configuration of the printing apparatus PRT. The controller CONT is connected to an input unit IP that inputs various information on the operation of the printing apparatus PRT, a memory unit MR that stores various information on the operation of the printing apparatus PRT. Further, the controller CONT is connected to the transportation mechanism CV, the head actuating mechanism AC, the maintenance mechanism MN and the like. The controller CONT is capable of controlling, for example, the capping mechanism CP, the wiping mechanism WP and the tube pump SC in the maintenance mechanism MN.

The printing apparatus PRT is provided with a driving signal generator 62 that generates driving signals to be input to the respective piezoelectric transducers 38. The driving signal generator 62 is connected to the controller CONT. The driving signal generator 62 receives data that indicate the amount of change in voltage of the ejection pulses to be input to the piezoelectric transducers 38 of the head H and timing signals that regulate the timing of changing the voltage of the ejection pulses The driving signal generator 62 can individually supply the driving signals to the respective piezoelectric transducers 38.

Next, the operation of the printing apparatus PRT having the above-mentioned configuration will be described. In a printing operation by the head H, the controller CONT places the medium M on the negative Z axis side of the head H by means of the transportation mechanism CV. After placing the medium M, the controller CONT controls the driving signal generator 62 corresponding to the nozzles NZ to input the driving signals to the piezoelectric transducers 38 based on the image data on the image to be printed while moving the head H.

Once the driving signals are input to the piezoelectric transducers 38, the piezoelectric transducers 38 expand and/or contract. The expansion and/or contraction of the piezoelectric transducer 38 change the volume of the pressure chamber 46, thereby causing variations in pressure of the pressure chamber 46 containing ink. The variations in pressure cause ink to be ejected through the nozzle NZ. By ink ejected through the nozzles NZ, an image is formed on the medium M as desired. Further, the above-mentioned first electrical signals may be supplied to the piezoelectric transducers 38 to expand and/or contract the piezoelectric transducers 38. Alternatively, driving signals different from the first electrical signals may be supplied to the piezoelectric transducers 38.

The controller CONT performs, for example, a cleaning operation as a maintenance operation of the head H.

The cleaning operation includes a capping operation, suctioning operation, wiping operation and the like.

The controller CONT first performs the capping operation. The controller CONT moves the head H to the home position so that the head H opposes the capping member 50 At the same time, the controller CONT moves the capping member 50 to the side of the head H, thereby pressing against the ejection plane Ha by means of a driving mechanism, which is not shown. This operation seals between the capping member 50 and the ejection plane Ha.

Next, the controller CONT performs the suctioning operation. After sealing between the head H and the capping member 50, the controller CONT actuates the tube pump SC. This operation suctions the capping member 50 which communicates with the tube pump SC to be in a negative pressure. The negative pressure between the head H and the capping member 50 causes ink to be suctioned (discharged) through the respective nozzles NZ of the head H. This enables to appropriately maintain the viscosity of ink in the nozzles NZ,

The suctioned ink flows from the capping member 50 via the waste ink tube 55, the tube pump SC and the waste ink tube 56 into the cylindrical member 73. As ink flows inside the cylindrical member 73, the turbine TU inside the cylindrical member 73 is rotated by the ink flow. After rotating the turbine TU, ink exits the opening 73a of the cylindrical member 73 and reaches the discharge position 80 of the first absorption member 61A. Then, ink is absorbed in the first absorption member 61A from the discharge position 80.

As the turbine TU rotates, the transmission shaft TR rotates integrally with the turbine TU. The rotation of the transmission shaft TR causes the first bevel gear 74 to rotate in the θY direction. The rotation of the first bevel gear 74 causes the second bevel gear 75 which meshes with the first bevel gear 74 to rotate in the θZ direction. As the second bevel gear 75 rotates, the shaft 76 and the first absorption member 61A rotates in the θZ direction.

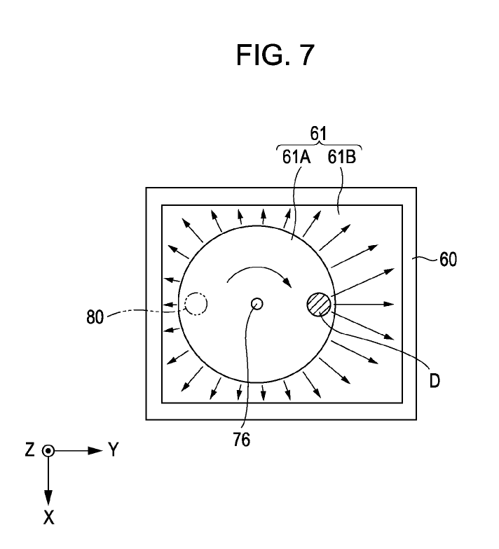

As shown in FIG. 7, this rotation causes the reach position 80 of the first absorption member 61A to be circularly moved about the shaft 76. Since the first absorption member 61A is configured to be in contact with the second absorption member 61B, the ink D is transferred from the first absorption member 61A to the second absorption member 61B. For example, the ink D reached the first absorption member 61A at the reach position 80 is rotated by approximately 170 degrees about the shaft 76 by the rotation of the first absorption member 61A. As a consequence, the ink D received in the absorption member 61 on the negative Y axis side in FIG. 7 moves to near the center of the absorption member 61 and evenly propagates as the ink D moves while permeating the second absorption member 61B. For example, the ink D permeates the second absorption member 61B on the positive Y axis side of the first absorption member 61A. Accordingly, even when the reach position 80 can not be positioned at the center of the absorption member, it is possible to move the apparent reach position, thereby eliminating the need to use the expensive absorption member having high permeability. Further, since the first absorption member 61A rotates approximately 170 degrees, the reach position 80 where ink is received changes with each rotation. This makes it possible to evenly distribute ink over the entirety of the first absorption member 61A. It should be noted that the discharged ink does not immediately permeate the absorption member, but gradually permeates as time elapses. Accordingly, the ink D does not always permeate from the position shown in FIG. 7. The ink D can permeate the entirety of the absorption member 61 from the various positions on the first absorption member 61A as indicated by the arrows in FIG. 7, since the position where the ink D permeates changes with each rotation. The reach position 80 is desirably located apart from the shaft 76 and close to the second absorption member 61B. This facilitates the permeation of the ink D into the second absorption member 61B and enables the even permeation since a plurality of positions for the ink D can be provided.

As mentioned above, it is possible to evenly distribute ink from the waste ink tube 56 to the absorption member 61 by operating the operating mechanism OP in conjunction with driving of the tube pump SC in this embodiment regardless of the material of the absorption member 61 and without providing a separate drive power source. This can reduce the cost of the printing apparatus PRT.

Further, in this embodiment, ink and the absorption member 61 are moved relatively to each other by moving the absorption member 61 using a relative driving mechanism RA (absorption member driving mechanism SA). Therefore, ink can be evenly distributed to the absorption member 61 in an efficient manner.

### Second Embodiment

Reference is now made to the drawings to describe a second embodiment of the invention. In this embodiment, the configuration of the waste ink recovering mechanism differs from that of the first embodiment, therefore the difference will be described below in detail. The remaining of the configuration of the waste ink recovering mechanism remains almost the same as that of the first embodiment, therefore the description is omitted or simplified.

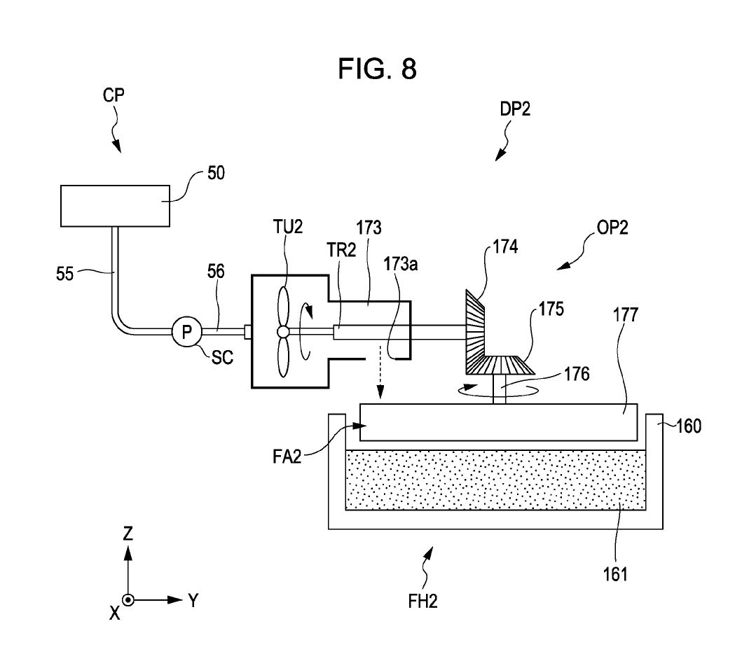

FIG. 8 is a view showing a configuration of a waste ink recovering mechanism DP2 according to the second embodiment. As shown in FIG. 8, the waste ink recovering mechanism DP2 includes a waste ink collecting mechanism FH2 and an operating mechanism OP2. The waste ink collecting mechanism FH2 has a container 160 and an absorption member 161. Unlike the first embodiment, the container 160 is provided, for example, in a fixed position. Further, the absorption member 161 is formed as a single unit.

The operating mechanism OP2 includes an ink driving mechanism FA2, a turbine TU2 and a transmission shaft TR2. The configurations of the turbine TU2 and the transmission shaft TR2 are the same as that of the first embodiment. The ink driving mechanism FA2 includes a first bevel gear 174, a second bevel gear 175, a shaft 176 and a stirring member 177. The stirring member 177 is arranged, for example, between the absorption member 161 and opening 173a of the cylindrical member 173. The stirring member 177 is disposed, for example, close to the absorption member 161 so as to be partially contained within the container 160.

In the configuration shown in FIG. 8, the suctioned ink in the capping mechanism CP flows into the cylindrical member 173. Then, similar to the first embodiment, the turbine TU2 is rotated by the ink flow. As the turbine TU2 rotates, the transmission shaft TR2 rotates integrally with the turbine TU2. The rotation of the transmission shaft TR2 causes the first bevel gear 174 to rotate in the θY direction, and then, the rotation of the first bevel gear 174 causes the second bevel gear 175 to rotate in the θZ direction. As the second bevel gear 175 rotates, the shaft 176 rotates to rotate the stirring member 177 in the θZ direction.

Meanwhile, ink that has flowed into the cylindrical member 173 exits the cylindrical member 173 through the opening 173a. Then, ink that has flowed out of the opening 173a reaches the absorption member 161 while being stirred in the OZ direction by the rotation of the stirring member 177, which is provided between the opening 173a and the absorption member 161. As a consequence, ink is distributed over the entirety of the absorption member 161.

As mentioned above, in this embodiment, ink and the absorption member 161 are moved relatively to each other by stirring ink using the stirring member 177 of the ink driving mechanism FA2 while keeping the absorption member 161 in a fixed position, therefore it is possible to evenly distribute ink to the absorption member 161 in an efficient manner,

### Third Embodiment

Next, a third embodiment of the invention is described below. In this embodiment, the configuration of the waste ink recovering mechanism differs from those of the above embodiments, therefore the difference will be described in detail. The remaining of the configuration of the waste ink recovering mechanism remains almost the same as that of the first embodiment, therefore the description is omitted or simplified.

The waste ink recovering mechanism DP3 includes a waste ink collecting mechanism FH3 and the operating mechanism OP3. The waste ink collecting mechanism FH3 includes a container 260 and an absorption member 261. The container 260 is formed, for example, in a cylindrical shape. The absorption member 261 is provided within the container 260 and, for example, formed integrally with the container 260. The absorption member 261 is made of, for example, a porous material so as to absorb ink. The absorption member 261 is arranged, for example, inside the container 260 without leaving a gap and detachably mounted in the container 260.

On the circular edge of the container 260, a first gear section 260a is formed in the circumferential direction. At the bottom of the container 260, a shaft 260b is provided. The shaft 260b is disposed at the center on the bottom of the container 260. The shaft 260b is rotatably supported by a support, which is not shown and is formed, for example, integrally with the container 260. Accordingly, when the shaft 260b rotates, the container 260 rotates integrally with the shaft 260b.

The operating mechanism OP3 includes and relative driving mechanism RA3, a turbine TU3 and a transmission shaft TR3. The turbine TU3 is rotatable by a flow of ink caused by the tube pump SC. The transmission shaft TR3 is configured to be rotatable integrally with the turbine TU3. The transmission shaft TR3 transmits a rotation force of the turbine TU3 to the relative driving mechanism RA3 as a driving force.

The relative driving mechanism RA3 moves ink and the absorption member 261 relative to each other. The relative driving mechanism RA3 has an ink driving mechanism FA3 that moves ink and an absorption member driving mechanism SA3 that rotates the absorption member 261. The ink driving mechanism FA3 includes threads 272 formed on the surface 271a of the transmission shaft TR3. The threads 272 are formed in a spiral shape in a direction of the rotation shaft of the transmission shaft TR3.

The turbine TU3, the transmission shaft TR3 and threads 272 are, for example, enclosed by a cylindrical member 273. The cylindrical member 273 is formed through which ink can flow. The cylindrical member 273 has a plurality of opening 273a. The openings 273a are arranged in the direction of the rotation shaft of the transmission shaft TR3. The openings 273a are, for example, oriented to the absorption member 261. Consequently, ink flowing in the cylindrical member 273 flows out of the openings 273a as appropriate such that ink is absorbed in the absorption member 261.

The absorption member driving mechanism SA3 includes a disk member 274 which is provided at the distal end of the transmission shaft TR3. The disk member 274 includes a second gear section 274a which is formed on the outer circumference thereof. The second gear section 274a is arranged so as to mesh with the first gear section 260a.

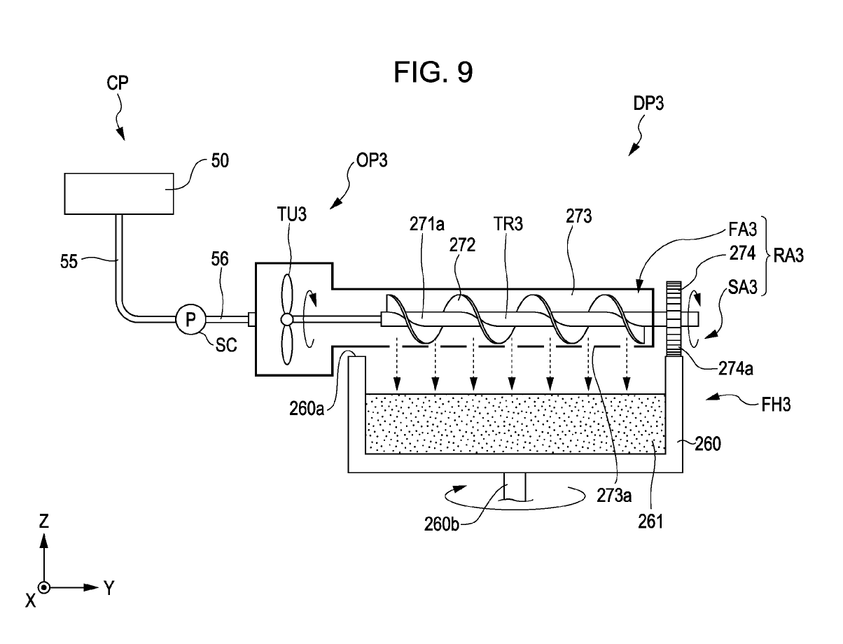

Next, the operation of the waste ink recovering mechanism DP3 having the above-mentioned configuration will be described. When the turbine TU3 rotates by the suctioned ink, the transmission shaft TR3 rotates integrally with the turbine TU3. This rotation of the transmission shaft TR3 rotates the threads 272, thereby transporting ink toward the distal end of the transmission shaft TR3 (positive Y direction in FIG. 9). Meanwhile, ink flows out of the cylindrical member 273 through the openings 273a and reaches the absorption member 261 so as to be absorbed into the absorption member 261.

Moreover, the rotation of the transmission shaft TR3 rotates the disk member 274, thereby allowing the second gear section 274a to transmit a rotation force to the first gear section 260a. This rotation force causes the container 260 to rotate about the shaft 260b. The rotation of the container 260 rotates the absorption member 261 contained in the container 260, The reach position for ink that has flowed out of the cylindrical member 273 through the openings 273a varies by the rotation of the absorption member 261. As a consequence, ink is absorbed over the entirety of the absorption member 261.

In this embodiment, ink and the absorption member 261 are moved relatively to each other by moving the absorption member 261 using the relative driving mechanism RA3 (ink driving mechanism FA3 and the absorption member driving mechanism SA3), therefore it is possible to evenly distribute ink to the absorption member 261 in an efficient manner.

The technical scope of the invention is not limited to the above-mentioned embodiments and can be modified as appropriately without departing from the spirit of the invention. For example, in the first embodiment, the position of the first absorption member 61A has been described as a position slightly offset from the center in the negative Y direction with respect to the container 60 in plan view, however it is not limited to the above position. For example, the first absorption member 61A may be positioned at the center of the container 60 in plan view, or alternatively, in the positive Y direction.

Further, the third embodiment may be configured to actuate the tube pump SC, for example, after the suction operation, with the capping member 50 being apart from the ejection plane Ha of the head H such that air is suctioned after ink. In this case, the turbine TU3 can be rotated by an air flow after the suctioned ink flows into the cylindrical member 273. As a consequence, the threads 272 can be rotated, thereby allowing ink remained in the cylindrical member 273 to be moved.

Further, although the above embodiments have been described as having the tube pump SC as a pump that pumps ink from the capping mechanism CP to the absorption member 61, the invention is not limited to this configuration and any other type of pump may be used. In addition, the configurations described in each embodiments can be used in combination as appropriate.

Further, although the ink jet printer and the ink cartridge are used in the above embodiments, a liquid ejecting apparatus that ejects or discharges liquid other than ink and a liquid container that contain liquid other than ink may be used. Alternatively, the invention can be utilized for various liquid ejecting apparatuses having liquid ejecting head or the like that ejects fine liquid droplets. It should be noted that liquid droplets ejected from the above-mentioned liquid ejecting apparatuses are intended to include liquid in a particle, tear drop or string shape.

The liquid as described herein may be any material that can be ejected from liquid ejecting apparatuses. For example, it may include a material in liquid phase such as liquid having high or low viscosity, sol, gel water, other inorganic solvent, organic solvent and liquid solution, and a material in melted state such as liquid resin and liquid metal (molten metal). Further, in addition to a material in a liquid state, it may include particles of functional material made of solid substance such as pigment and metal particles, which is solved, dispersed or mixed in a solvent. Further, typical examples of liquid include ink, liquid crystal or the like as mentioned in the above embodiments, The ink as described herein includes various liquid components such as general water-based ink, oil-based ink, gel ink and hot melt ink.

Specific examples of liquid ejecting apparatus may include, for example, liquid ejecting apparatuses that eject liquid containing materials such as electrode material and color material in a dispersed of dissolved state, which are used for manufacturing of liquid crystal displays, EL (electroluminescence) displays, surface emitting displays or color filters, liquid ejecting apparatuses that eject bioorganic materials used for manufacturing biochips, liquid ejecting apparatuses that are used as a precision pipette and eject liquid of a sample, textile printing apparatuses and micro dispensers.

Examples of liquid ejecting apparatus may further include liquid ejecting apparatuses that eject lubricant to precision instrument such as a clock or camera in a pinpoint manner, liquid ejecting apparatuses that eject transparent resin liquid such as ultraviolet cured resin on a substrate for manufacturing of minute hemispheric lenses (optical lenses) used for optical communication elements or the like, and liquid ejecting apparatuses that eject acid or alkali etching liquid for etching a substrate or the like. In addition, the invention is applicable to one liquid ejecting thereof and the liquid storing unit. The invention is applicable to an ejection apparatus and a liquid container for any one of the above examples.

What is claimed is:

1. A fluid ejecting apparatus comprising:
a fluid ejecting head that ejects fluid;
a fluid receiving unit that receives the fluid ejected from the fluid ejecting head;
a fluid absorbing unit that is connected to the fluid receiving unit via a flow channel and absorbs the fluid;
a pump that is provided on the flow channel and pumps the fluid from the fluid receiving unit to the fluid absorbing unit; and
an actuating unit that moves the fluid ejected from the flow channel from an area where the fluid is ejected in conjunction with actuation of the pump.

2. The fluid ejecting apparatus according to claim 1, wherein the actuating unit includes a relative driving mechanism that moves the fluid ejected to the fluid absorbing unit to an area other than where the fluid is ejected.

3. The fluid ejecting apparatus according to claim 2, wherein the relative driving mechanism includes an absorbing unit driving mechanism that actuates a portion of the fluid absorbing unit.

4. The fluid ejecting apparatus according to claim 3, wherein the fluid absorbing unit includes a first absorption member provided at a position where the fluid is ejected from the flow channel and a second absorption member provided in contact with the first absorption member, and wherein the absorbing unit driving mechanism includes a rotating mechanism that rotates the first absorption member.

5. The fluid ejecting apparatus according to claim 1, wherein the actuating unit includes a relative driving mechanism that moves the ejected fluid to an area wider than the area where the fluid is ejected.

6. The fluid ejecting apparatus according to claim 5, wherein the actuating unit includes a turbine that rotates due to a fluid flow caused by the pump and a transmission mechanism that is rotatable integrally with the turbine and transmits a rotation force of the turbine to the relative driving mechanism as a driving force.

7. The fluid ejecting apparatus according to claim 6, wherein the transmission mechanism includes a shaft member that is connected to the turbine and rotates integrally with the turbine, and wherein the relative driving mechanism includes threads formed in a spiral shape on the surface of the shaft member.

8. The fluid ejecting apparatus according to claim 6, wherein the relative driving mechanism includes a stirring mechanism that stirs the fluid between the flow channel and the fluid absorbing unit.
